(19) United States
(12) Patent Application Publication
(10) Pub. No.: US 2011/0055247 A1
(43) Pub. Date: Mar. 3, 2011

(54) PROVIDER-SPECIFIC BRANDING OF GENERIC MOBILE REAL ESTATE SEARCH APPLICATION

(76) Inventors: Brad W. Blumberg, Vorrhees, NJ (US); Eric M. Blumberg, Ventnor, NJ (US)

(21) Appl. No.: 12/552,151

(22) Filed: Sep. 1, 2009

(51) Int. Cl. G06F 17/30

(52) U.S. Cl. 707/769; 707/E17.108

(57) ABSTRACT

In one embodiment, a method comprises receiving an application download request, the request including an entity indicator associated with an entity from a plurality of entities, sending the application to a wireless device and sending a set of formatting information based at least in part on the entity indicator.

### BACKGROUND

Embodiments described herein relate generally to location- and/or entity-based information searching, and more particularly to methods and apparatus for the branded presentation of location and/or entity-based search results on a mobile device.

Individuals and organizations often utilize computerized search technologies when seeking information associated with a specific geographic region or a particular entity, such as a commercial entity. For example, individuals are often engaged in a search for potential real estate properties within a given region that is currently available for purchase, lease, or rent. Some technologies match the searcher's specified criteria to a number of available properties and provide the results along with contact information to allow for the formation of an agent-client relationship. Alternatively, an individual may engage in a search for information associated with a specific commercial entity. In the real estate scenario described above, an individual may, for example, seek potential purchase properties offered by a specific real estate agent or company.

Many technology-based services are provided by real estate companies and their associated agents in an effort to simplify the search process and thus incentivize individuals and organizations to work with that company during their search. While providing such services can result in increased business for the company, some of this benefit can be counteracted by the significant costs inherent in development and deployment of associated software across multiple platforms.

Traditional, computer-based property search technologies suffer from an inability to provide service during impromptu, in-the-field property browsing sessions which generally take place in a searcher's automobile. Further, many services suffer from an inability to tailor their marketing and deployment efforts specifically to properties in the company's regions of business and strength. This results in an imprecise mapping between the geographic areas where the company does business and those encompassed by its search services, leading to user dissatisfaction when a search produces few or inadequate results for an area where the company does not do business. Because such dissatisfaction has the potential to result in negative user impressions of the company, more precise targeting of search services in a company's areas of business activity is desirable.

Thus, a need exists for methods and apparatus that significantly reduce the financial and logistical costs of deploying a location- and/or entity-based computerized search application, such as a real estate search application. A need further exists for methods and apparatus that offer such a service on wireless and mobile devices in a manner that allows entities to offer access to this service form within their existing distribution channels as well as offer targeted branding of another version of the application based on a specified physical location or other criteria. An additional need exists for methods and apparatus that provide branded search results based on the current physical location of the requesting mobile device and/or an entity currently associated with the device. Finally, a need exists for methods and apparatus that facilitate delivery of customized versions of mobile software applications to a user device based on details associated with and/or characteristics of the device, such as, for example, carrier, manufacturer, device and software platform.

### SUMMARY

In one embodiment, a method includes receiving an application download request, the request including an entity indicator associated with an entity from a plurality of entities, sending the application to a wireless device and sending a set of formatting information based at least in part on the entity indicator.

### BRIEF DESCRIPTION OF THE DRAWINGS

FIG. 1 is a schematic diagram that illustrates a wireless device and property information and formatting server, each coupled to a communication network, according to an embodiment.

FIG. 2 is a flowchart that illustrates a method of receiving at a wireless device a set of relevant properties selected and formatted responsive to a property search query and a location indicator, according to an embodiment.

FIG. 3 is a schematic diagram that illustrates an exemplary display of a set of formatted search results at a mobile device, according to an embodiment.

FIG. 4 is a schematic diagram that illustrates an exemplary display, at a mobile device, of a set of mapped property results and of a mobile device physical location, according to an embodiment.

FIG. 5 is a schematic diagram that illustrates an exemplary branded property search application download process, according to an embodiment.

FIG. 6 is a flowchart that illustrates a method for receiving a property search application and formatting information at a wireless device based on request origin information, according to an embodiment.

FIG. 7 is a flowchart that illustrates a method for requesting, identifying, and receiving a device-specific search application that is based on the carrier, device and platform of the requesting device.

FIG. 8 is a flowchart that illustrates a method of receiving at a wireless device a set of relevant properties selected and formatted responsive to a property search query and a location indicator with an entity tag, according to an embodiment.

### DETAILED DESCRIPTION

A property information and formatting server can be configured to generate and transmit property search results responsive to user-defined criteria and a current geographic location of and/or an entity associated with a requesting wireless device. In some embodiments, the server can additionally determine and transmit formatting information associated with an entity that is associated with a geographic region that is associated with the current geographic location of the wireless device. In some embodiments, the server can be configured to generate map information that when transmitted to the wireless device allows for the display of one or more property results on a two- or three-dimensional map. In some embodiments, the server can be configured to generate voice translation information that when transmitted to the wireless device allows for the audio explanation of one or more property results with entity audio branding.

In some embodiments, an application download server can be configured to receive an application download request from a wireless device or personal computing device via a communication network. In some embodiments, the download server can extract additional information from the download request and utilize the information to determine, for example, a home region associated with the wireless device, a carrier of the wireless device, executable application type of the software device, an entity associated with the home region, an entity associated with user-supplied data such as a request-originating company website, text code, phone number, etc. In some embodiments, the download server can select a compatible version of a wireless property search application for transmission to the wireless device. In some embodiments, the download server can determine an entity associated with one or more of: the home region of the wireless device, the current physical location of the wireless device, the originating website of the download request, or other user-defined information. In some embodiments, the additional information can be extracted, determined or received by a device-identification module stored and/or executed on a same device as the application download server, or, alternatively, on a different device from the application download server.

The download server can send formatting information associated with the entity to the wireless device so that the property search application can be presented according to the formatting information. As the physical location of the wireless device changes, or as the user specifies alternative information in subsequent download requests, the download server can provide updated formatting information such that the property search application is always presented according to formatting information of an entity associated with the current physical location of the device or the most-recent user-defined information. In some embodiments, the formatting information can be determined based at least in part on, for example, an entity associated with the device.

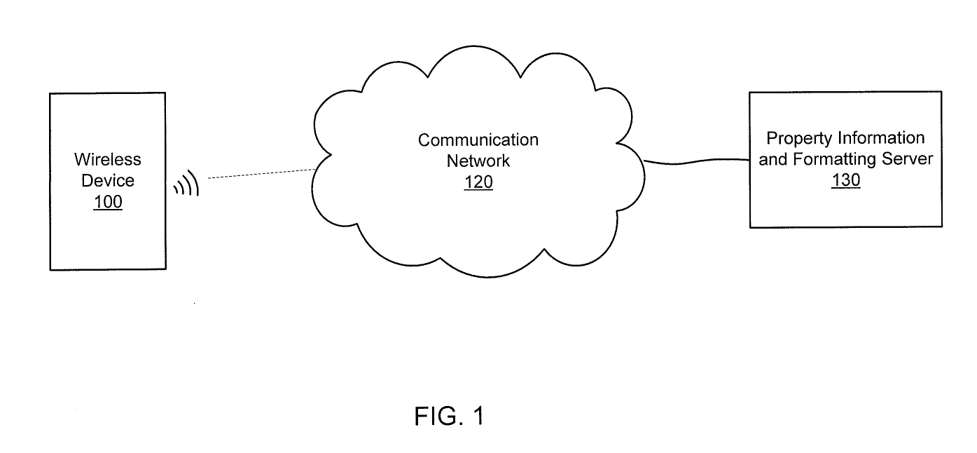

FIG. 1 is a schematic diagram that illustrates a wireless device and property information and formatting server, each coupled to a communication network, according to an embodiment. Specifically, FIG. 1 illustrates a wireless device 100 wirelessly coupled to a communication network 120. The communication network 120 is operatively coupled to a property information and formatting server 130 (“property server”).

Wireless device 100 can be, for example, a mobile (cellular or VoIP-enabled) telephone, a personal digital assistant (PDA), a laptop, notebook, or netbook computer, a tablet computing device, a geographic positioning satellite (GPS) navigation device, a portable digital audio player (DAP), or similar mobile electronic device.

Communication network 120 can be, for example, a cellular telephone network, a plain-old telephone service (POTS) network, a hybrid cellular-POTS network, a local area network (LAN), a wide area network (WAN), the Internet, or other wireless communication network based on a short-range protocol such as infrared, Bluetooth, Ultra Wide Band (UWB), wireless USB, Wi-Fi, WiMax, etc.

Property server 130 can be comprised of one or more modules, each of which may be implemented, for example, in hardware (e.g., a processor, an application-specific integrated circuit (ASIC), or a field programmable gate array (FPGA)), and/or in software that resides on a hardware device (e.g., a processor) or in a memory (e.g., a RAM, a ROM, a hard disk drive, an optical drive, or other removable media) coupled to a processor. The one or more modules can be implemented and/or resident on devices connected over, for example, a network such as a local area network (LAN), a wide area network (WAN), the Internet, and/or a wireless data connection, such as a Bluetooth or infrared connection.

Wireless device 100 can be configured to send one or more wireless signals that include a property search query. In some embodiments, the property search query can include one or more property search criteria as well as an entity identifier. The signals that include the property search query can be received at and transported over communication network 120 to property server 130.

In some embodiments, property server 130 can be configured to receive the property search query and determine a set of property results that match parameters included therein. The property server can be further configured to determine an entity associated with the property search query and corresponding formatting information and data associated with that entity. Upon determining the set of property results and the entity, property server 130 can send one or more response signals that include the set of property results and the formatting information to wireless device 100 via communication network 120. Upon receipt of the response signals from the property server, wireless device 100 can display the set of property results according to the formatting information.

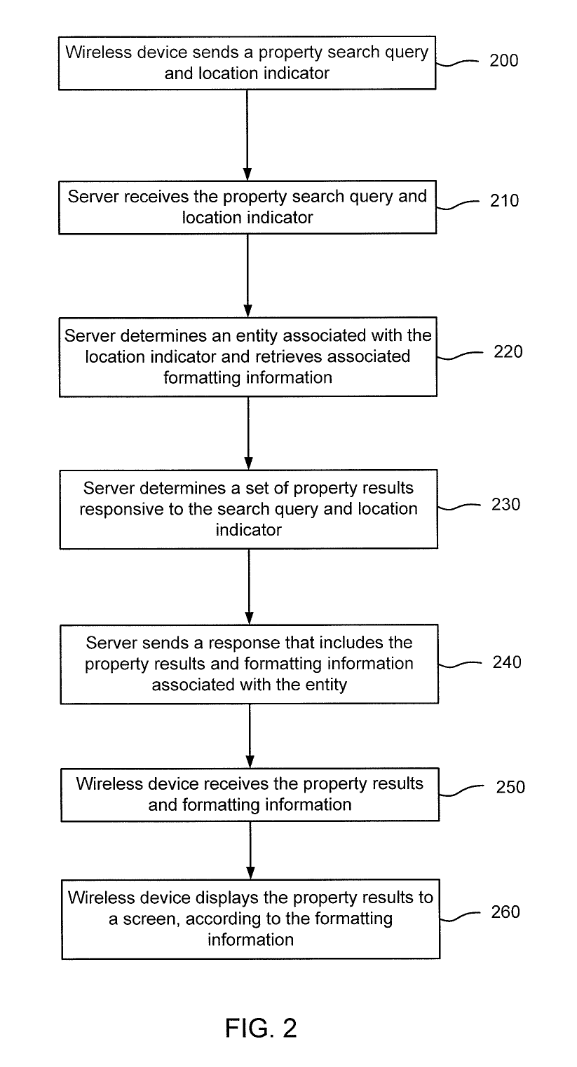

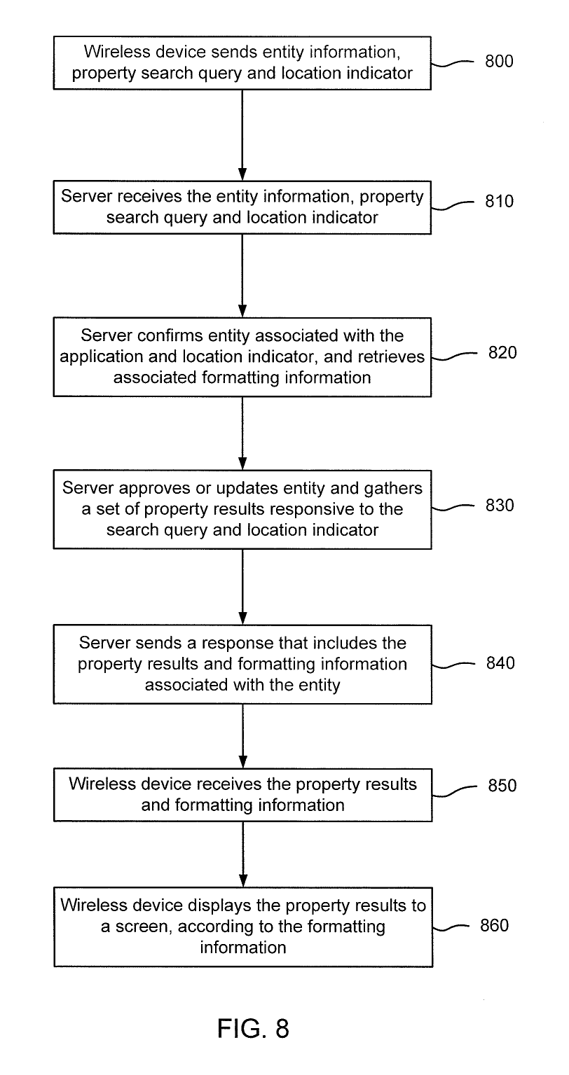

FIG. 2 is a flowchart that illustrates a method of receiving at a wireless device data associated with a set of relevant properties selected and formatted responsive to a property search query and a location indicator, according to an embodiment. (FIG. 8 is a similar flowchart that illustrates a similar method wherein the wireless device request includes an entity indicator.) As shown in FIG. 2, a wireless device can send a property search query and location indicator, 200. The property search query can include, for example, one or more search criteria that indicate a user's desired property characteristics. The one or more search criteria can include, for example, entity data restrictions, property type, property price range, property room configuration information, number of bedrooms, number of bathrooms, square footage range, physical location, garage presence, transaction type (e.g., sale, lease, rent), and other similar property search criteria. In some embodiments, the wireless device can send a search query associated with a different type of requested information, such as automobiles for sale, available doctors in a given region, best prices for pharmaceuticals under a specific plan or at large, etc. As such, the search criteria mentioned above that is associated with a given search can vary based on the particular nature of the search.

In some embodiments, the location indicator can be programmatically determined by the wireless device based on that device's current geographic position. For example, the wireless device can be configured to determine its current geographic position using one or more of: geographic positioning satellite (GPS) technology, cellular telephone tower triangulation, a correlation between an Internet Protocol (IP) address of the device and a geographic region, a physical location of a Wi-Fi hotspot to which the wireless device is currently connected, etc. In some embodiments, the location indicator can be specified by a user via user input to the wireless device. The location indicator can include, for example, longitude and latitude information or other information sufficient to indicate the current geographic location of the wireless device.

In some embodiments, the location indicator can be, alternatively, an entity indicator. The entity indicator can be assigned to a particular device if, for example, the user has requested or downloaded a branded version of a mobile search application from that entity. In such embodiments, the entity indicator can be stored locally on a memory included in or operatively coupled to the wireless device.

A server can receive the property search query and location indicator, 210. In some embodiments, the server can be coupled to a communication network such as a cellular telephone network. In such an embodiment, the server can receive the property search query and location indicator from the wireless device via one or more of: a text message, an electronic mail message, a web page, a mobile device application, voice and/or keypad commands transmitted via a landline or Voice over Internet Protocol telephone call, or other signaling convention.

The server can determine an entity associated with the location indicator, and retrieve associated formatting information, 220. In some embodiments, the server can additionally receive information indicating an origin of the query, such as, for example, a text code, a unique phone number, an entity id, etc. In some embodiments, the server can store the query information to a memory for subsequent use. In some embodiments, an entity can be associated with one or more geographic regions. An entity may choose to be associated with a particular geographic region, for example, because that entity does business in that geographic region. Thus, the entity may seek to capture the business of property searchers in that region by supplying property search results along with its own specified formatting and contact information whenever a search is initiated from a mobile device currently located somewhere within that associated geographic region. In some embodiments, the server can determine a geographic region—and thus an associated entity—by determining a geographic region that includes the physical location indicated by the location indicator. In some embodiments, the search query can include an entity indicator based on user entry of entity information from, for example, a list of one or more available entities. In some embodiments, the list can be based on a location of the wireless device, a previous user entity selection, one or more sponsored entities, and/or entity information associated with an initial data or application download request made by the user. In some embodiments, if the search query includes an entity indicator, the server can omit the step of determining an entity.

A geographic region can be defined by, for example, geographic coordinates or roadways, or a political region such as a town, city, county, province, state, etc. An entity can be, for example, a real estate agent, a real estate company, a property search application company, a bank, an insurance company, an automobile or other vehicle dealership, or any other entity, business, or organization that wishes to associate itself with search results for one or more relevant geographic regions (as determined by the location indicator).

After determining an associated entity, the server can be configured to determine formatting information associated with that entity. The formatting information can allow for property search results to be presented according to a visual format dictated by the entity. The visual format can include, for example, graphic and entity logo information, entity-selected color scheme information, font information, additional on-screen features and the like. In some embodiments, if the query includes an entity indicator and the server determines that the formatting information has already been downloaded by the wireless device, the server can omit the step of determining the formatting information. In some embodiments, the server can store the formatting information to a memory operatively coupled to or included in the server. In some embodiments, the server can determine an entity based on a previous entity selection associated with a user. In some embodiments, the server can store an entity-user relationship to a memory, such as a back-end database, for subsequent use. In some embodiments, the server can store additional information sufficient to define and/or identify the user, including, for example, user telephone information, user mailing address information, user name information, user username information, user identification number information, device-specific information associated with a user, etc.

The server can determine a set of properties responsive to the search query and location indicator, 230. Specifically, the server can utilize the location indicator and other property search query criteria to determine one or more matching property results. In some embodiments, the server can be configured to query a property database that stores information regarding available properties. The property database can be, for example a relational database management system (RDBMS). The server can be configured to query the property database using, for example, structured query language (SQL) or another database query language. In some embodiments, the property database can be stored in a computer memory on the same device as the server. Alternatively, the property database can be stored on one or more external devices coupled to the server over a network or the Internet. In some embodiments, the property database can be stored on one or more fixed mediums such as, for example, one or more flash memory drives, optical discs, or memory cards. In some embodiments, one or more search results can be stored to a memory on the server.

The server can send a response that includes the property results and formatting information associated with the entity, 240. The response can include information about the property results, including, for example, one or more image files of each property and basic property information for each property, such as mailing address, physical dimensions, property type, asking price, associated realtor, associated realty company, picture information, estimated mortgage information, tax information, layout configuration, contact information and the like. In some embodiments, if the query includes an entity indicator and the server determines that the formatting information has already been downloaded by the wireless device, the server can omit the step of transmitting the formatting information so as to improve query response time and efficiency.

The wireless device can receive the property results and formatting information, 250. In some embodiments, the wireless device can display the property results to a screen, according to the formatting information, 260.

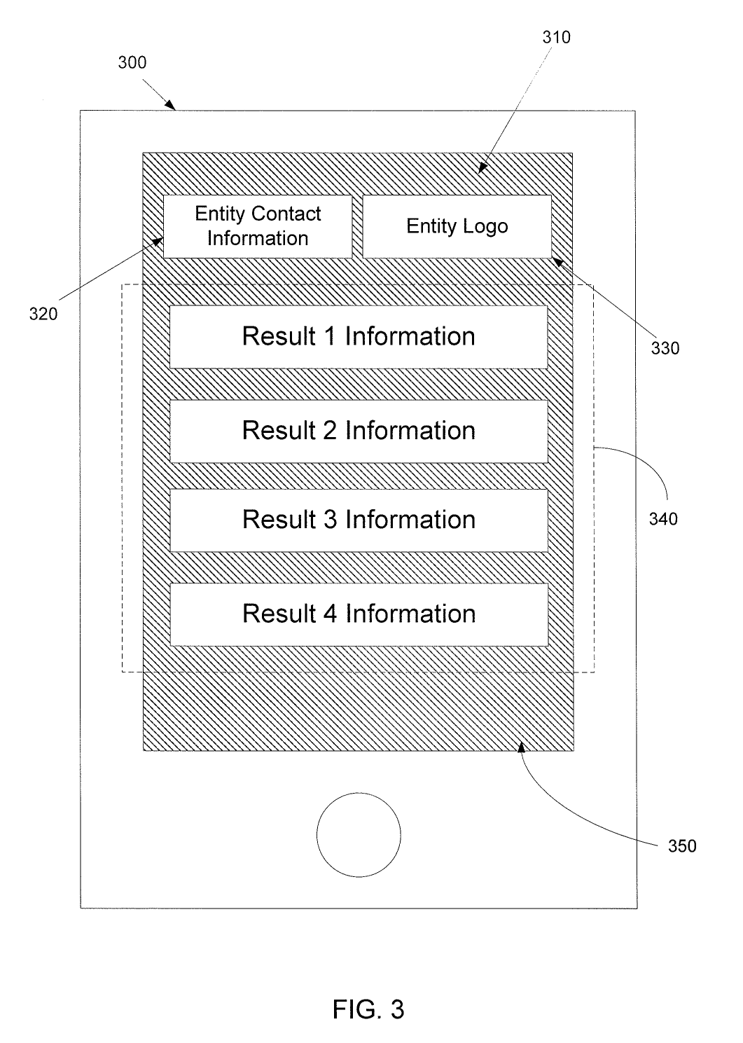

FIG. 3 is a schematic diagram that illustrates an example of a display of a set of formatted search results at a mobile device, according to an embodiment. Specifically, FIG. 3 illustrates a mobile device 300 with a screen 310 configured to display entity contact information 320, an entity logo 330, a set of formatted search results 340 and result formatting information, such as a background display color 350.

In some embodiments, mobile device 300 includes a touchscreen, but in other embodiments the mobile device can be a cellular telephone with a keypad, a portable media player, laptop computer with a keyboard, or any other mobile electronic device capable of emitting a wireless data signal and exchanging data via the same. Screen 310 can be, for example, a liquid crystal display (LCD) screen, a light-emitting diode (LED) screen, or other monochrome or color screen capable of displaying search result information using text and/or images. Entity contact information 320 can include, for example, entity telephone information, entity e-mail address information, entity website address information and/or entity mailing address information. In some embodiments, entity contact information 320 can include common contact information for that entity, such that all attempts to contact the entity via the contact information direct individuals to the same point of contact. Entity logo 330 can be, for example, an image file depicting a logo associated with an entity or other image file or graphic.

Formatted search results 340 can include information associated with one or more results returned by a search query similar to the property search query discussed in connection with FIG. 2 above. In some embodiments, each search result from formatted search results 340 can be, for example, a property search query result that includes information associated with that search result. For example, information associated with a property search query result can be, for example, one or more of: an image of that property, property price, property address, a number of bedrooms in that property, a number of bathrooms in that property, and a physical proximity of that property to a current geographic location of the mobile device (calculated using a location indicator such as the location indicator associated with FIG. 2).

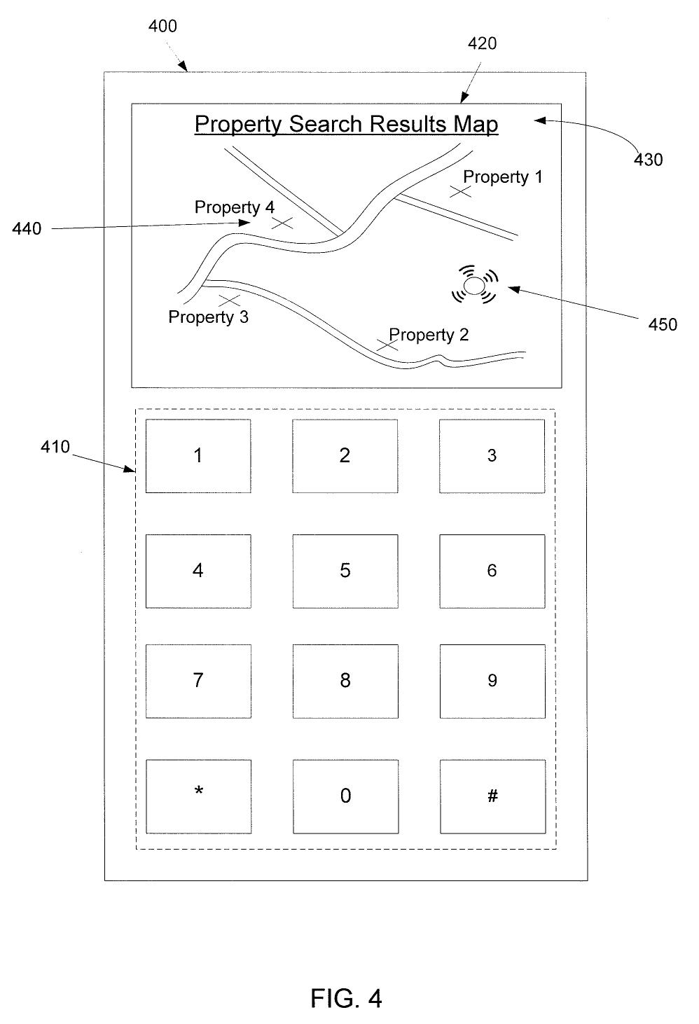

In some embodiments, screen 310 can display, for example, image and/or additional information associated with the search results. In some embodiments, the image and/or additional information can be one or more of: real estate agent contact information, an image of a real estate agent associated with one or more properties, a link to a map of properties included in formatted search results 340 (as discussed in connection with FIG. 4 below), a link to call an associated agent, or other additional functionality. In some embodiments, screen 310 can display a link that when selected allows a user to save information regarding one or more properties from formatted search results 340 to a memory for access at a later time. In some embodiments, information regarding the one or more search results can be stored to a memory of mobile device 300 (not shown) or to a memory of a search server (not shown) such as that discussed in connection with FIG. 1 above.

FIG. 4 is a schematic diagram that illustrates an example of a mobile telephone display of a set of mapped property results and of a mobile telephone current location marker, according to an embodiment. Specifically, FIG. 4 illustrates mobile telephone 400 containing a numeric keypad 410 and a screen 420. In the figure, screen 420 displays a property search results map 430, which includes a property marker 440 and a mobile telephone current location marker 450. Property search results map 430 visually represents the geographic locations of a set of property search results such as those discussed in connection with FIG. 2 above, and the current geographic location of mobile telephone 400 (on which it is displayed).

In some embodiments, the mobile telephone can be configured to update the position of the current location marker on the screen as the physical location of the telephone changes. In some embodiments, the mobile telephone can be configured to adjust the zoom level of the search results map responsive to the pressing of one or more input buttons from a numeric keypad, so as to allow a user to view a wider or narrower longitudinal and latitudinal range. In some embodiments, the map zoom level and other presentation parameters of the property search results map can be varied based on various forms of user input, such as, for example, the pressing of input buttons, the tapping or swiping of a digital stylus on the screen, or the tapping, swiping or “pinching” of a finger on the screen. In some embodiments, entity branding is maintained across screen views such as those enumerated above.

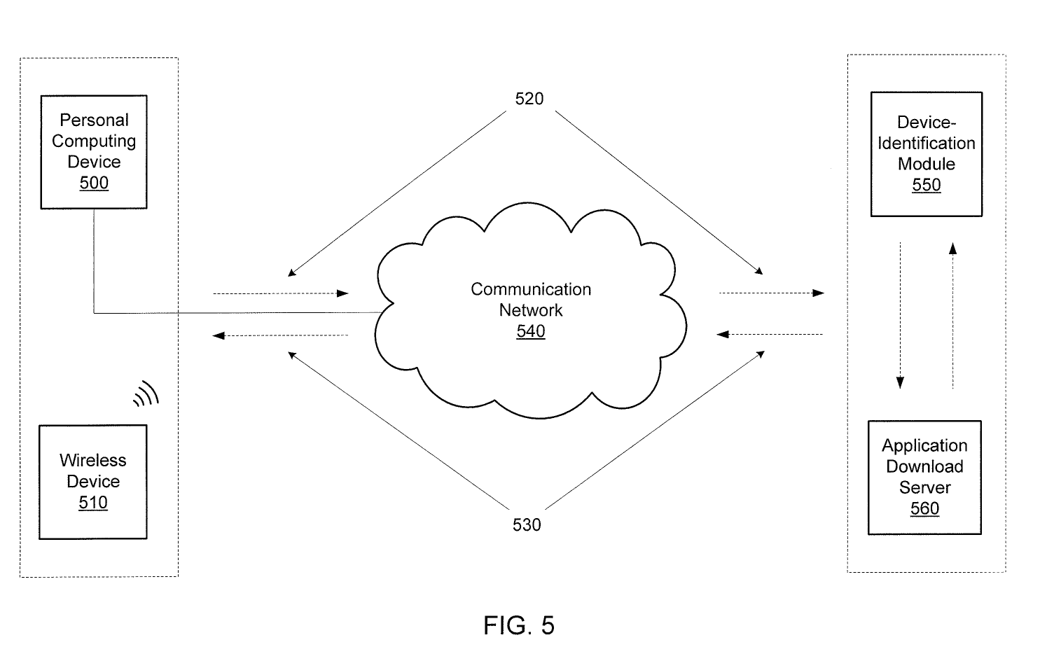

FIG. 5 is a schematic diagram that illustrates an example of a branded property search application download process, according to an embodiment. Specifically, FIG. 5 illustrates a personal computing device 500 and a wireless device 510, each in communication with a device-identification module 550 and an application download server 560 via a communication network 540. Personal computing device 500 and wireless device 510 can each be configured to access device-identification module 550 and subsequently send an application download request 520 to application download server 560 via communication network 540. Personal computing device 500 and wireless device 510 can each be further configured to receive an application download response 530 from application download server 560 via communication network 540.

Personal computing device 500 can be a personal computer, an Internet kiosk, or other standalone device connected to communication network 540 via a wired link (such as a digital subscriber line (DSL), coaxial cable, fiber-optic (such as Verizon FiOS), or dial-up telephone modem connection) or wireless link such as those enumerated below. Wireless device 510 can be connected to communication network 540 via a wireless link, such as, for example, a cellular network connection (e.g., using GSM, CDMA, TDMA, or LTE protocols), a Wi-Fi connection, or WiMax connection. Communication network 540 can be, for example, a cellular telephone network, a plain-old telephone service (POTS) network, a hybrid cellular-POTS network, a local area network (LAN), a wide area network (WAN), the Internet, or other wireless communication network based on a short-range protocol such as infrared, Bluetooth, Ultra Wide Band (UWB), wireless USB, Wi-Fi, WiMax, etc.

Device-identification module 550 can be a hardware- and/or software-based module configured to assist a user in downloading an optimized mobile application version for the user's mobile device. In some embodiments, code and/or other information associated with the device-identification module can be stored on the same device or server as application download server 550. In some embodiments, the device-identification module 550 and application download server 560 can be stored on separate devices configured to communicate via, for example, a network (as shown), such as a local area network (LAN), wide area network (WAN), or the Internet.

Application download server 560 can include one or more modules (not shown), each of which may be implemented, for example, in hardware and/or software. The one or more modules can be implemented and/or resident in a single hardware device, or, alternatively, in multiple devices connected over, for example, a local area network (LAN), a wide area network (WAN), the Internet, and/or a wireless data connection, such as a Bluetooth or infrared connection. Alternatively, application download server 560 can include of one or more software components that reside in the memory of one or more computerized devices (not shown).

In some embodiments, personal computing device 500 or wireless device 510 can be configured to access device-identification module 550 via communication network 540. For example, wireless device 510 can be configured to send a text message to application download server 560, or to another server (not shown) associated with the provider of a mobile search application. In some embodiments, the text message can include information configured to associate the wireless device 510 with a particular entity, such as a real estate agency. The wireless device 510 can then receive a response text message that includes addressing information (such as a URL) associated with device-identification module 550. Upon receipt of the response text message, a user can then access device-identification module 550 using, for example, a mobile web browser on the wireless device or a web browser program running on a personal computing device. In some embodiments, a user can receive the response text message in response to a telephone call placed on a conventional landline telephone, mobile device, Voice over Internet Protocol (VoIP) device, or other voice-capable device. For example, in some embodiments a user can place a telephone call to an automated call response system (not shown), and via entry of voice and/or keypad information, enter information associated with a mobile device and/or an entity. In some embodiments, a user can access device-identification module 550 by directly entering addressing information associated with the device-identification module into a mobile web browser on the wireless device.

In some embodiments, a user can access device-identification module 550 using a personal computing device 500. For example, a user can enter a telephone number associated with wireless device 510 on, for example, a webpage associated with a carrier associated with the device, with a property search entity (such as a real estate agent or service), with another commercial such as an insurance company, etc. In some embodiments, one or more servers associated with receipt of the telephone number information (not shown) can be configured to send a text message to wireless device 510 that includes addressing information of the device-identification module 550. In some embodiments, the text message and/or addressing information can include information configured to associate the wireless device 510 with a particular entity, with multiple entities, or with a portal that assigns an entity to a device based on a specified search location or region.

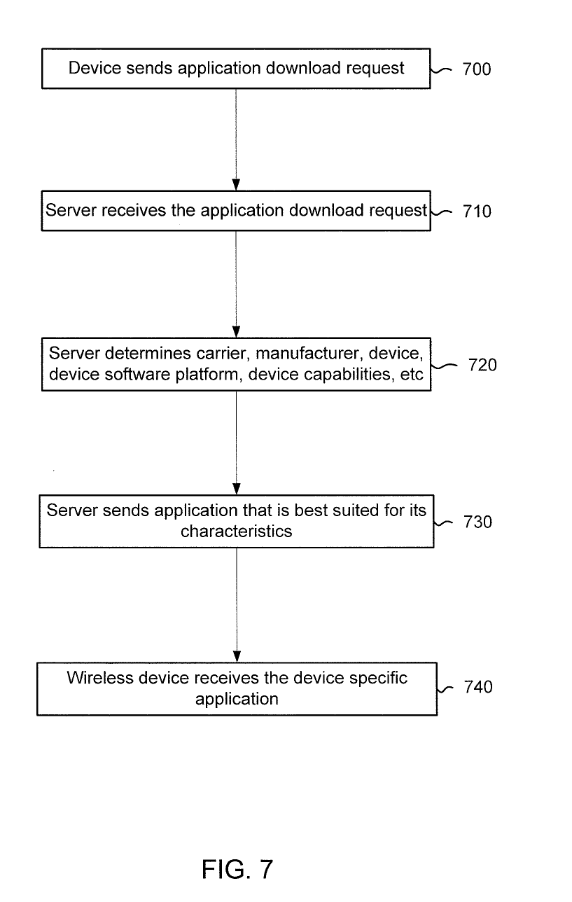

Upon receipt of the addressing information associated with device-identification module 550, the wireless device 510 or personal computing device 500 can send one or more signals (not shown) that include a request to receive access to the device-identification module via communication network 540. In some embodiments, device-identification module 550 can be configured to receive the request and grant access. In some embodiments, device-identification module 550 can identify information associated with wireless device 510, such as, for example, a cellular telephone carrier, a device model, or a device type, as shown in FIG. 7.

In some embodiments, upon determination of a carrier associated with the wireless device, device-identification module 550 can direct wireless device 510 or personal computing device 500 to an appropriate download location. For example, if wireless device 510 is an Apple iPhone mobile telephone, the device-identification module can be configured to redirect the device to, for example, the Apple iTunes store. If, for example, the wireless device is a Verizon Blackberry Curve mobile device, the device-identification module can be configured to redirect the device to, for example, an application store associated with Blackberry devices and/or Verizon devices. In some embodiments, a user can enter device input commands configured to initiate download of the mobile application by wireless device 510. In some embodiments, wireless device 510 can be redirected to a mobile web version of the mobile application, such as a Wireless Application Protocol (WAP) version of the application.

In some embodiments, device-identification module 550 can be configured to provide a link or other addressing information that allows the user to initiate a download of the appropriate wireless application version from application download server 550. In such embodiments, the user can access the link using a desktop web browser running on personal computing device 500 or a mobile web browser running on wireless device 510, thereby initiating transmission of an application download request 520 to application download server 550. In some embodiments, the link or other addressing information can include information configured to cause the wireless device 510 to download a particular branded version of the mobile application, the branding being based at least in part on an entity associated with the wireless device 510, as shown in FIG. 7.

In some embodiments, device identification module 550 can be configured to provide, to the wireless device, a list of two or more available versions of the selected mobile application. For example, the list can include a free version of the selected application and an advanced, paid version of the selected application. If the selected application is a mobile property search application, an advanced version can include, for example, improved search performance and/or additional features such as an interactive map, automatic billing, and location-based property search. A free version can be, for example a WAP version of the application that offers a reduced feature set when compared to the advanced version. In some embodiments, a free version of an application can be configured to alert the user to the availability of an advanced or other version of the application, and provide a link whereby the user may download the other version to their device in exchange, for example, for a fee. In some embodiments, a free and/or other version of the selected application can be configured to notify the user when a new or updated version of the application is available and, optionally, provide functionality allowing the user to acquire the new or updated version. Further functionality relating to transmission and receipt of the mobile application is included below.

In some embodiments, personal computing device 500 or wireless device 510 can be configured to transmit a download request 520 to application download server 500 directly, without first accessing device-identification module 550, as shown in FIG. 7. For example, in some embodiments, personal computing device 500 can be configured to receive a user instruction (not shown) to transmit a download request 520. In some embodiments, download request 520 can include a request to download a mobile search application such as that discussed in connection with FIG. 1. In some embodiments, download request 520 can request that an e-mail or text message be sent that includes an embedded link allowing the download of the mobile search application to wireless device 510. In some embodiments, the link can include information configured to associate wireless device 510 with a particular entity. Alternatively, in some embodiments, download request 520 can be configured to request that the mobile search application be downloaded directly to personal computing device 500 for subsequent syncing and transfer to wireless device 510. The user instruction can be received, for example, via user input received in the context of a web page of a real estate service, real estate agent, or other entity, such as an automobile dealer, an insurance company, etc. Alternatively, the user instruction can be received in the context of an online wireless application store such as the Apple iTunes App Store associated with the Apple iPhone cellular telephone.

In some embodiments, wireless device 510 can be configured to receive, from a user, an instruction (not shown) to transmit a download request 520. The instruction can be received in the context of a mobile web page of a real estate service, real estate agent, or other entity, or, alternatively, from within an online wireless application store. In some embodiments, download request 520 can be transmitted via an http request, a text message, or an e-mail message sent from wireless device 500 to application download server 560 via communication network 540. In some embodiments, download request 520 can be transmitted via a keypad or voice data entry transmitted over a telephone, such as a traditional landline telephone, a mobile telephone, or Voice over Internet Protocol (VoIP) telephone.

In some embodiments, download request 520 can include request origin information configured to assist application download server 560 in formulating an application download response 530. If download request 520 originates from wireless device 510, the origin information can include information about wireless device 510, such as, for example, a model type of wireless device 510, a telephone number associated with wireless device 510, a location indicator calculated based on the current geographic location of wireless device 510, a current web address of a browser located on or associated with wireless device 510, a wireless carrier associated with wireless device 510, an entity associated with the wireless device 510, etc. (as shown in FIG. 7). If download request 500 originates from personal computing device 500, the origin information can include, for example, a current web address of a browser located on or associated with personal computing device 500, an entity indicator associated with the current web address, a user-specified entity, a user-specified cellular telephone number, a user-specified cellular carrier, etc.

Upon receipt of download request 520, application download server 560 can be configured to send an application download response 530 to the requesting device, be it personal computing device 500, wireless device 510, or another similar device capable of receiving a wireless application download.

In some embodiments, application download server 560 can be configured to extract request origin information from download request 520 for use in customizing its corresponding application download response 530. More specifically, application download server 560 can determine both a compatible version of a mobile search application and appropriate formatting information to include in the download response, based at least in part on the request origin information. In some embodiments, if application download server 560 receives an application download request 520 that includes an indication that the requesting device is a particular cellular telephone model, the server can be configured to determine what types of applications the requesting device is capable of executing. For example, if the requesting device is only capable of executing Wireless Application Protocol (WAP) applications, application download server 560 can send an application download response 530 that includes an executable WAP version of the mobile search application. Alternatively, if application download server 560 receives an application download request 520 including device model information indicating that the requesting device is a BlackBerry Storm or Google Android cellular telephone, application download server 560 can prepare and transmit a download response 530 that includes an appropriate, rich-content version of the mobile search application, compatible with the requesting device's hardware and software.

In some embodiments, application download server 560 can be further configured to extract request origin information from download request 520 and make additional determinations to determine further appropriate details relating to its creation of download response 530. For example, application download server 560 can extract from download request 520 telephone number information associated with wireless device 510 and utilize the information to determine a home region associated with the telephone number area code. This home region information can optionally be matched to an entity associated with the region, allowing application download server 560 to tailor download response 530 to a device associated with that region as discussed below.

In an example, application download server 560 can utilize the wireless device's telephone number and/or other information to determine unique identifying information associated with the device (such as a carrier associated with the device), thus allowing the server to include in download response 530 an optimal version of the mobile search application tailored to the model type of and carrier associated with the device (as shown in FIG. 7). In some embodiments, user and/or device identification information can be used to define secure access to entity-related data.

In some embodiments, application download server 560 can be configured to determine a set of formatting information to be associated with the mobile search application and included in the download response 530. This formatting information can be determined based on, for example, one or more of an entity associated with a region in which the requesting device is currently located, a wireless carrier associated with wireless device 510 (determined using telephone number information associated with wireless device 510 as described above), originating information associated with download request 520 (such as an entity associated with a webpage from which the request was initiated), etc.

In some embodiments, the formatting information can include a color scheme, logo and contact information of an entity determined based on the originating information. The formatting information can be included in download response 530 along with an appropriate version of the mobile search application, allowing the application to generate a branded presentation of property search results on wireless user device 510. In this way, an entity is able to distribute a branded version of the mobile search application to interested parties whenever a download request 520 is made either from a website associated with the entity or from a physical location located within a geographic region associated with the entity.

In an example, an application download server receives from a wireless device an application download request that includes model information indicating that the wireless device is an Apple iPhone mobile telephone and device location information indicating that the device is currently located in Wichita, Kans. Upon receipt of the download request and associated request origin information, the download server performs a lookup operation and determines that the entity Acme Real Estate Company is associated with the geographic region encompassing Wichita, Kans. Responsive to this determination, the download server sends, across a cellular telephone network, an iPhone version of a mobile search application accompanied by formatting information associated with Acme Real Estate Company retrieved from a database. Upon receipt of the application and formatting information, a user can operate the wireless device so as to request and receive property search results based on user-defined criteria (including, e.g., the current geographic location of the device) and formatted according to the Acme Real Estate formatting information. In the example, if the application download server receives a subsequent request from the same wireless device while the device is physically located within a second geographic region associated with a second entity, the server can be configured to send formatting data of the second entity for display on the device along with any searches executed and results received while the device is physically located within the second geographic region. This process can be repeated, such that the formatting information associated with the mobile search application is always consistent with an entity associated with the current geographic region in which the device is physically located.

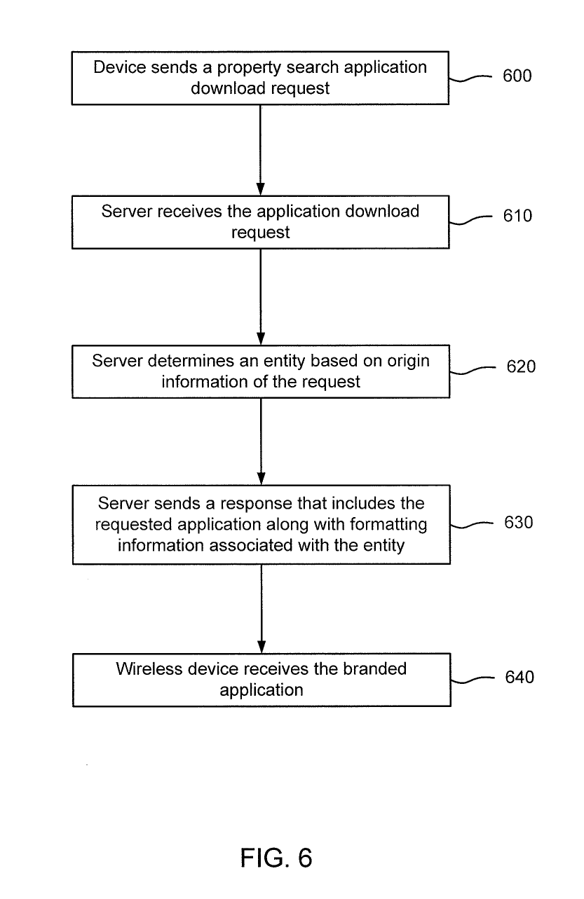

FIG. 6 is a flowchart that illustrates a method for receiving a mobile search application and formatting information at a wireless device based on request origin information, according to an embodiment. As shown in FIG. 6, a device can send a mobile search application download request, 600. The device can be, for example, a wireless device or other electronic device communicatively coupled to a communication network. A server can receive the application download request, 610. The server can be, for example, a computerized device or server coupled to a communication network.

The server can determine an entity based on origin information of the request, 620. In some embodiments, the server can utilize geographic information associated with the request to determine an entity, such as a real estate entity that is associated with a matching geographic region. In some embodiments, the server can determine that no entity is associated with the geographic information.

The server can send a response that includes the requested application, along with formatting information associated with the entity, 630. In some embodiments, the server can utilize the entity identified in step 620 to determine a set of formatting data associated with that entity. The server can be configured to then return the requested application along with the formatting data. In some embodiments, if no entity is determined in step 620, the server can be configured to send generic formatting data along with the requested application.

A wireless device can receive the branded application, 640. In some embodiments, the wireless device can receive the requested application and formatting data (the branded application) via a wireless network such as a cellular network, or, for example, via a wired or wireless sync operation with another user device, such as a personal computer.

FIG. 7 is a flowchart that illustrates a method for requesting, identifying, and receiving a device-specific search application that is based on the carrier, device and platform of the requesting device.

FIG. 8 is a flowchart that illustrates a method of receiving at a wireless device a set of relevant properties selected and formatted responsive to a property search query and a location indicator with an entity tag, according to an embodiment.

The embodiments described herein relate to a computer storage product with a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files that contain higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, in some embodiments, a wireless device can be associated with one or more entities such as the entity discussed in connection with FIG. 2. Additionally, the wireless device, can, for example, receive search query results and formatting information associated with any of the one or more entities, based on, for example, a physical location of the wireless device, a search location of the search query, an entity-device association, a source of the mobile search application, an entity associated with a particular version of the mobile search application, etc. In some embodiments, formatting information associated with a mobile search application and/or mobile search results can be based on an absence of an entity-device association.

What is claimed is:

1. A method, comprising:
receiving a request, the request including a property search query that includes a location indicator;
sending, in response to the request, a plurality of property results based at least in part on the location indicator, at least one result from the set including information associated with a property; and
sending a set of formatting data associated with an entity from a plurality of entities.

2. The method of claim 1, wherein the entity is associated with the location indicator.

3. The method of claim 1, wherein the location indicator is based on one or more of:
location information entered by a user; and
location information defined by a wireless device.

4. The method of claim 1, wherein the location indicator is associated with location coordinates of a wireless device, the location coordinates being determined based at least in part on one or more of:
global positioning system information associated with the wireless device;
cellular network tower location information associated with the location coordinates;
location information of a communication device operatively coupled to the wireless device; and
user entry of location information.

5. The method of claim 1, wherein the request is a first request, the property search query is a first property search query, the location indicator is a first location indicator, the plurality of property results is a first plurality of property results, the set of formatting data is a first set of formatting data, and the entity is a first entity, the method further comprising:
receiving a second request, the second request including a second property search query that includes a second location indicator;
sending, in response to the second request, a second plurality of property results based at least in part on the second location indicator, at least one result from the second set including information associated with a property; and
sending a second set of formatting data based on a second entity from the plurality of entities.

6. The method of claim 1, wherein each property result from the plurality of property results includes information associated with a property and at least one of:
picture information associated with the property;
address information associated with the property;
property type information associated with the property;
pricing information associated with the property;
estimated mortgage information for the property;
tax information for the property;
layout configuration information for the property; or
contact information associated with the entity.

7. The method of claim 1, further comprising:
sending map information to the wireless device, the map information being based at least in part on the location indicator and one property result from the plurality of property results; and
sending property location information to the wireless device, the property location information being based at least in part on the one property result.

8. The method of claim 1, wherein the request includes at least one of:
search region information;
desired property type information;
desired property price range information; or
desired property room configuration information.

9. The method of claim 1, wherein the entity is a user-selected entity, further comprising:
sending a list of two or more entities; and
receiving a signal that includes an entity selection.

10. The method of claim 9, wherein the list of two or more entities is based at least in part on one or more of:
a location of the wireless device;
a previous entity selection;
one or more sponsored entities; and
entity information associated with an original data request.

11. A computer-readable storage medium comprising code representing instructions to cause a processor to:
define a location indicator based on a physical location of a wireless device;
receive property query information from a user;
send a request, the request including the property query information and the location indicator;
receive a response, the response including at least one property result and a set of formatting data; and
display the at least one property result in accordance with the set of formatting data.

12. The computer-readable storage medium of claim 11, wherein the set of formatting data is associated with the location indicator.

13. The computer-readable storage medium of claim 11, wherein the code representing instructions to cause a processor to define a location indicator further comprises code to determine the physical location of the wireless device based on at least one of:
global positioning system information associated with the wireless device;
cellular network tower location information associated with the wireless device;
location information of a communication device operatively coupled to the wireless device; or
user input.

14. The computer-readable storage medium of claim 11, further comprising code representing instructions to cause a processor to:
store the property query information to a memory in response to user input.

15. The computer-readable storage medium of claim 11, further comprising code representing instructions to cause a processor to:
store the at least one property result to a memory in response to user input.

16. The computer-readable storage medium of claim 11, further comprising code representing instructions to cause a processor to:
store the set of formatting data to a memory.

17. A method, comprising:
determining a physical location of a wireless device based on at least one of:
global positioning system information associated with the wireless device;
cellular network tower location information associated with the wireless device;
location information of a communication device operatively coupled to the wireless device; or
user input;
defining a location indicator based on the physical location;
sending a request, the request including a property search query that includes the location indicator;
receiving a plurality of property results, at least one property result from the plurality of property results including information regarding a property within a predetermined distance from the physical location; and
displaying a portion of the plurality of property results to a screen coupled to the wireless device, the displaying including a set of formatting data associated with an entity from a plurality of entities.

18. The method of claim 17, wherein the entity is associated with the location indicator.

19. The method of claim 17, wherein the physical location is a first physical location, the request is a first request, the property search query is a first property search query, the location indicator is a first location indicator, the plurality of property results is a first plurality of property results, the predetermined distance is a first predetermined distance, the set of formatting data is a first set of formatting data, and the entity is a first entity, further comprising:
determining a second physical location of the wireless device;
defining a second location indicator based on the second physical location;
sending a second request, the second request including a second property search query that includes the second location indicator;
receiving a second plurality of property results, each property result from the second set of search query results including information regarding a property within a second predetermined distance from the second physical location; or
displaying a portion of the second set of search query results to the screen coupled to the wireless device in accordance with a second set of formatting data associated with a second entity from the plurality of entities.

20. The method of claim 17, wherein each property result from the plurality of property results includes information associated with a property and at least one of:
picture information associated with the property;
address information associated with the property;
property type information associated with the property;
pricing information associated with the property;
estimated mortgage information for the property;
tax information for the property;
layout configuration information for the property; or
contact information associated with the entity.

21. The method of claim 17, further comprising:
sending, to the wireless device, map information, the map information being based at least in part on the location indicator and one property result from the plurality of property results; and
sending, to the wireless device, property location information, the property location information being based at least in part on the one property result.

22. The method of claim 17, wherein the property search query includes at least one of:
search region information;
desired property type information;
desired property price range information; or
desired property room configuration information.

23. A method, comprising:
receiving a request, the request including a search query;
sending, in response to the request, a plurality of results and a set of formatting data, the set of formatting data being based at least in part on a location indicator associated with at least one result from the plurality of results.

24. The method of claim 23, wherein the search query is a property search query, the plurality of results is a plurality of property results and the location indicator is a property location indicator.

25. The method of claim 23, wherein the location indicator is associated with an entity.

26. The method of claim 24, wherein the request is a first request, the property search query is a first property search query, the location indicator is a first location indicator, the plurality of property results is a first plurality of property results and the set of formatting data is a first set of formatting data, the method further comprising:
receiving a second request, the second request including a second property search query;
sending, in response to the second request, a second plurality of property results and a second set of formatting data, the second set of formatting data being based at least in part on a second location indicator, different from the first location indicator, associated with at least one result from the second plurality of property results.

27. The method of claim 23, wherein each property result from the plurality of property results includes information associated with a property and at least one of:
picture information associated with the property;
address information associated with the property;
property type information associated with the property;
pricing information associated with the property;
estimated mortgage information for the property;
tax information for the property;
layout configuration information for the property; or
contact information associated with the entity.

28. A method, comprising:
receiving an application download request from a wireless device, the request including location information and at least one of:
a model type of the wireless device;
a model number of the wireless device;
a serial number of the wireless device;
wireless carrier information associated with the wireless device; or
a telephone number associated with the wireless device; and
sending the application to the wireless device, the application including branding information based at least in part on the location information.

29. The method of claim 28, wherein the location information is based at least in part on a physical location of the wireless device.

30. The method of claim 28, wherein the application, when executed, displays branding information based at least in part on an entity associated with the location information.

31. The method of claim 30, further comprising:
defining a user identifier based at least in part on one or more of:
user e-mail address information;
user telephone number information;
user mailing address information;
user name information;
user username information;
user identification number information; and
device-specific information associated with a user; and
associating the user identifier with the entity.

32. The method of claim 31, wherein the application including the branding information includes a first set of branding information, the entity is a first entity and the application, when executed, displays a second set of branding information associated with a second entity.

33. The method of claim 32, wherein the location information is a first location information and the second entity is associated with a second location information.

34. A method, comprising:
receiving an application download request, the request including an entity indicator associated with an entity from a plurality of entities;
sending the application to a wireless device; and
sending a set of formatting information based at least in part on the entity indicator.

35. The method of claim 34, further comprising defining a user identifier based at least in part on the entity indicator and at least one of:
user e-mail address information;
user telephone number information;
user username information; or
user identification number information.

36. The method of claim 35, wherein the application download request is a first application download request, the entity indicator is a first entity indicator, and the set of formatting information is a first set of formatting information, further comprising:
receiving a second application download request, the second request including a second entity indicator associated with a second entity from the plurality of entities;
updating the user identifier based at least in part on the second entity indicator; and
sending a second set of formatting information based at least in part on the user identifier.

37. The method of claim 34, wherein the application is a property search application.

38. The method of claim 34, wherein the entity indicator is based at least in part on location information associated with the wireless device.
